(19) United States
(12) Patent Application Publication
(10) Pub. No.: US 2025/0052099 A1
(43) Pub. Date: Feb. 13, 2025

(54) Charging Port or Fueling Port Cover Assembly

(71) Applicant: Illinois Tool Works Inc., Glenview, IL (US)

(72) Inventor: Yuan SUN, Shanghai (CN)

(21) Appl. No.: 18/797,633

(22) Filed: Aug. 8, 2024

(30) Foreign Application Priority Data
Aug. 10, 2023 (CN) 202311004326.7
Jul. 26, 2024 (CN) 202411017711.X

(51) Int. Cl. E05D 3/14; E05F 15/00

(52) U.S. Cl. CPC E05D 3/145; E05F 15/00; E05Y 2900/534

(57) ABSTRACT

The present disclosure provides a charging port or fueling port cover assembly, including: a housing, a cover, and a linkage mechanism, wherein the housing has a working area and a linkage mating area; the cover is movable relative to the housing and has an open position and a closed position, the cover covers the working area in the closed position, and the cover exposes the working area in the open position; the linkage mechanism passes through the linkage mating area to be connected to the cover, and the linkage mechanism is movable in the linkage mating area to drive the cover to move between the open position and the closed position; and wherein the cover is translatable from one to the other of the open position and the closed position. The charging port or fueling port cover assembly in the present disclosure has a small thickness.

### RELATED APPLICATIONS

The present application claims the benefit of Chinese Patent Application Nos. 202311004326.7, filed Aug. 10, 2023, and 202411017711.X, filed Jul. 26, 2024, each titled “CHARGING PORT OR FUELING PORT COVER ASSEMBLY,” the contents of which are hereby incorporated by reference.

### TECHNICAL FIELD

The present disclosure relates to a charging port or fueling port cover assembly, and in particular to a fueling port or charging port cover assembly applicable to a vehicle.

### BACKGROUND

A fueling port cover or a charging port cover of a vehicle is configured to expose or cover a fueling port or a charging port of the vehicle. The fueling port cover or the charging port cover is rotatably mounted on a vehicle body. The fueling port cover or the charging port cover has an open position and a closed position, and the fueling port cover or the charging port cover can be moved between the open position and the closed position. When fueling or charging is not required, the fueling port cover or the charging port cover needs to be in the closed position. When fueling is required, the fueling port cover or the charging port cover needs to be in the open position.

### SUMMARY

The present disclosure relates generally to a charging port cover, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a charging port or fueling port cover assembly according to a first embodiment of the present disclosure.

FIG. 1B is an exploded view of the charging port or fueling port cover assembly of FIG. 1A.

FIG. 2A is a perspective view of a housing of FIG. 1B.

FIG. 2B is a perspective view of the housing of FIG. 2A from another angle.

FIG. 3A is a perspective view of a cover of FIG. 1B.

FIG. 3B is a perspective view of the cover of FIG. 3A from another angle.

FIG. 4A is a perspective view of a linkage mechanism of FIG. 1B.

FIG. 4B is a side view of the linkage mechanism of FIG. 4A.

FIG. 5A is a perspective view of the charging port or fueling port cover assembly of FIG. 1A with the housing hidden.

FIG. 5B is a perspective view of the charging port or fueling port cover assembly of FIG. 5A with the housing hidden from another angle.

FIG. 6A is a perspective view of the charging port or fueling port cover assembly of FIG. 1A with the cover in a closed position.

FIG. 6B is a perspective view of the charging port or fueling port cover assembly of FIG. 1A with the cover in an open position.

FIG. 7A is a side view of the charging port or fueling port cover assembly of FIG. 6A.

FIG. 7B is a side view of the charging port or fueling port cover assembly of FIG. 6A with the housing hidden.

FIG. 7C is a side view of the charging port or fueling port cover assembly of FIG. 6B.

FIG. 7D is a side view of the charging port or fueling port cover assembly of FIG. 6B with the housing hidden.

FIG. 8A is a perspective view of a charging port or fueling port cover assembly according to a second embodiment of the present disclosure.

FIG. 8B is a perspective view of the charging port or fueling port cover assembly of FIG. 8A from another angle.

FIG. 9 is a side view of a linkage mechanism of FIG. 8A.

FIG. 10A is a perspective view of a charging port or fueling port cover assembly according to a third embodiment of the present disclosure with a housing omitted.

FIG. 10B is a side view of a linkage mechanism and a cover of FIG. 10A with the cover in a closed position.

FIG. 10C is a side view of the linkage mechanism and the cover of FIG. 10A with the cover in an open position.

FIG. 11A is a perspective view of a charging port or fueling port cover assembly according to a fourth embodiment of the present disclosure with a housing omitted.

FIG. 11B is a side view of a linkage mechanism and a cover of FIG. 11A with the cover in a closed position.

FIG. 11C is a side view of the linkage mechanism and the cover of FIG. 11A with the cover in an open position.

### DETAILED DESCRIPTION

Various specific embodiments of the present disclosure are described below with reference to the drawings which constitute part of this description. It should be understood that although the terms indicating directions such as “front”, “rear”, “upper”, “lower”, “left” and “right” are used in the present disclosure to describe various exemplary structural parts and elements of the present disclosure, these terms are used herein only for ease of description and are determined based on the exemplary orientations shown in the drawings. Since the arrangements in the embodiments disclosed in the present disclosure may be in various directions, these terms indicating directions are only illustrative and should not be considered as limitations. If possible, the same or similar reference numerals used in the present disclosure refer to the same components.

The present disclosure provides a charging port or fueling port cover assembly, comprising: a housing, a cover, and a linkage mechanism, wherein the housing has a working area and a linkage mating area; the cover is movable relative to the housing and has an open position and a closed position, the cover covers the working area in the closed position, and the cover exposes the working area in the open position; the linkage mechanism passes through the linkage mating area to be connected to the cover, and the linkage mechanism is movable in the linkage mating area to drive the cover to move between the open position and the closed position; and wherein the cover is configured to be translatable from one to the other of the open position and the closed position.

In the charging port or fueling port cover assembly as described above, the linkage mechanism includes a first connecting rod and a second connecting rod, the first connecting rod and the second connecting rod being arranged offset from each other.

In the charging port or fueling port cover assembly as described above, the housing includes a linkage receiving area, the linkage receiving area being connected to the linkage mating area and extending from the linkage mating area in the first direction, and at least a portion of each of the first connecting rod and the second connecting rod is capable of entering the linkage receiving area when the cover is in the closed position.

In the charging port or fueling port cover assembly as described above, the first connecting rod includes a first upper connecting portion, a first gooseneck portion and a first lower connecting portion, the first upper connecting portion being hinged to the cover; the second connecting rod includes a second upper connecting portion, a second gooseneck portion and a second lower connecting portion, the second upper connecting portion being hinged to the cover; at least one of the first lower connecting portion and the second lower connecting portion is connected to a power device; and a connecting shaft for connecting the first upper connecting portion and the cover and a connecting shaft for connecting the second upper connecting portion and the cover are arranged non-coaxially.

In the charging port or fueling port cover assembly as described above, the first gooseneck portion and the second gooseneck portion include a first curved section and a second curved section, respectively, an outer surface of the first curved section forming a first circular arc, an outer surface of the second curved section forming a second circular arc, the first lower connecting portion coinciding with a center of circle of the first circular arc, the second lower connecting portion coinciding with a center of circle of the second circular arc, and a connecting shaft for the first lower connecting portion and a connecting shaft for the second lower connecting portion are arranged non-coaxially; the first gooseneck portion includes a first upper smooth section and a first lower smooth section, and the second gooseneck portion includes a second upper smooth section and a second lower smooth section, the first upper smooth section extending from one end of the first curved section in a direction away from the center of circle of the first circular arc, the second upper smooth section extending from one end of the second curved section in a direction away from the center of circle of the second circular arc; and the first lower smooth section extending from one end of the first curved section in a direction proximate to the center of circle of the first circular arc, and the second lower smooth section extending from one end of the second curved section in a direction proximate to the center of circle of the second circular arc.

In the charging port or fueling port cover assembly as described above, during the movement of the cover between the open position and the closed position, the first curved section, the second curved section, the first lower smooth section and the second lower smooth section are all located upstream or downstream of the working area in a movement direction of the cover.

The charging port or fueling port cover assembly as described above further includes: a power device, wherein one of the first lower connecting portion and the second lower connecting portion is connected to the power device and is configured to be driven by the power device to rotate, so as to drive the corresponding connecting rod to rotate, and the other thereof is hinged to the housing.

In the charging port or fueling port cover assembly as described above, the linkage mating area is arranged upstream or downstream of the working area in a movement direction of the cover.

In the charging port or fueling port cover assembly as described above, the linkage mating area includes at least one linkage opening penetrating the housing, the linkage opening having an inside edge proximate to the working area, and the inside edge extending smoothly.

In the charging port or fueling port cover assembly as described above, at the linkage opening, an outer surface of the first curved section coincides with an outer surface of the second curved section.

In the charging port or fueling port cover assembly as described above, the linkage mating area includes two linkage openings penetrating the housing, the two linkage openings being configured to receive the first connecting rod and the second connecting rod, respectively.

In the charging port or fueling port cover assembly as described above, the cover has a first side portion and a second side portion; and in a direction of moving the cover from the closed position to the open position, the first side portion is located upstream of the second side portion, and the connection of the linkage mechanism and the cover is proximate to the second side portion.

In the charging port or fueling port cover assembly as described above, a substantially arc-shaped trajectory is formed by the translational movement of the cover between the closed position and the open position.

In the charging port or fueling port cover assembly as described above, the working area has a working opening for mounting a charging port or a fueling port.

In the charging port or fueling port cover assembly as described above, the first connecting rod and the second connecting rod have substantially the same shape.

The linkage mechanism further includes a transmission device connected to the first connecting rod and the second connecting rod, the transmission device being configured such that as one of the first connecting rod and the second connecting rod moves, the other thereof is driven to move via the transmission device.

In the charging port or fueling port cover assembly as described above, the transmission device is arranged at parts of the first connecting rod and the second connecting rod away from the cover.

In the charging port or fueling port cover assembly as described above, the transmission device is made of a rigid material.

In the charging port or fueling port cover assembly as described above, the transmission device includes a connecting member, two ends of the connecting member being pivotally connected to the first connecting rod and the second connecting rod, respectively.

In the charging port or fueling port cover assembly as described above, the transmission device includes a first gear, a second gear and at least one third gear, the first gear being fixedly connected to the first connecting rod, the second gear being fixedly connected to the second connecting rod, and the at least one third gear being meshable with the first gear and the second gear.

The present disclosure further provides a vehicle including a charging port or fueling port cover assembly as described in any one of the above.

The fueling port cover or charging port assembly in the present disclosure has a housing, a cover, and a linkage mechanism which can drive the cover to move translationally relative to the housing. The housing has a working area corresponding to the charging port or fueling port, and a receiving area of the linkage mechanism is staggered with the working area, so that the housing can be configured to have a small thickness in the working area, and the working area is neat and aesthetically pleasing.

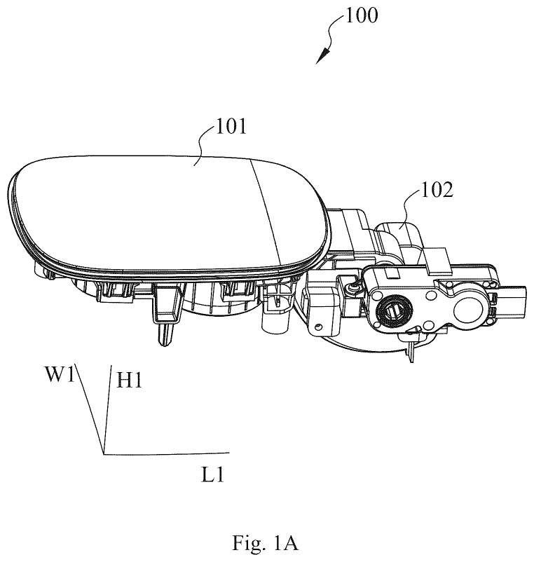

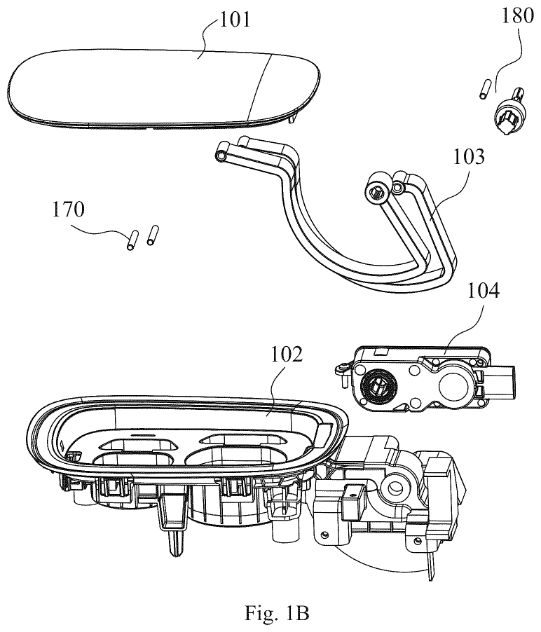

FIG. 1A is a perspective view of a charging port or fueling port cover assembly according to a first embodiment of the present disclosure, and FIG. 1B is an exploded view of the charging port or fueling port cover assembly of FIG. 1A. As shown in FIGS. 1A and 1B, the charging port or fueling port cover assembly 100 includes a housing 102, a cover 101, a linkage mechanism 103, and a power device 104. The housing 102 can be connected to a fueling port or a charging port. The power device 104 is mounted in the housing 102. One end of the linkage mechanism 103 is connected to the cover 101 via a shaft assembly 170, and the other end of the linkage mechanism 103 is connected to the power device 104 and the housing 102 via a shaft assembly 180. The power device 104 can drive the linkage mechanism 103 to rotate, so as to drive the cover 101 to move between a closed position and an open position of the cover 101 relative to the housing 102, thereby covering or exposing a fueling port or a charging port connected to the housing 102. The shaft assembly 170 and the shaft assembly 180 each include a pair of shafts.

As shown in FIG. 1A, the charging port or fueling port cover assembly has a height direction H1, a length direction L1, and a width direction W1. During the movement of the cover 101 between the closed position and the open position relative to the housing 102, the cover 101 translates relative to the housing along the height direction H1 and in the length direction L1. That is, during the movement of the cover 101 between the open position and the closed position, each part of the cover is moved by an equal distance relative to the corresponding part of the housing, and the movement trajectory of each part of the cover has the same shape. In this embodiment, the length direction L1 is defined as a first direction and the height direction H1 is defined as a second direction. The cover 101 can move relative to the housing 102 in the first direction, and can move relative to the housing 102 in the second direction. The movement of the cover 101 relative to the housing 102 causes the cover 101 to be displaced relative to the housing 102 in the first direction and in the second direction.

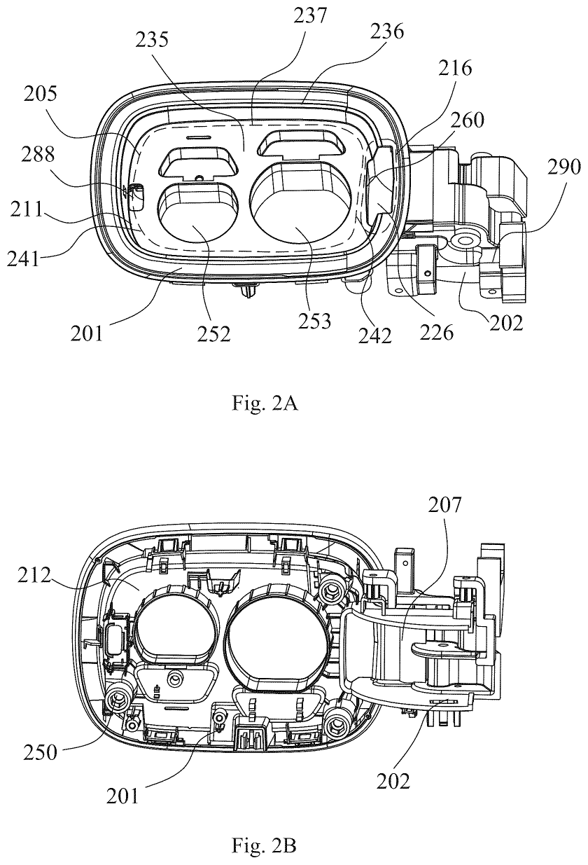

FIG. 2A is a perspective view of the housing of FIG. 1B, and FIG. 2B is a perspective view of the housing of FIG. 2A from another angle. FIGS. 2A and 2B show the front and back of the housing 102.

As shown in FIGS. 2A and 2B, the housing 102 includes a main body 201 and a side portion 202. The main body 201 has a front side 211 and a rear side 212 arranged opposite to each other. The front side 211 is arranged toward the cover 101, and the rear side 212 is arranged toward the interior of a vehicle. The housing 102 has a bottom portion 235 and a side edge 236. The side edge 236 extends away from a periphery of the bottom portion 235 and encloses a receiving space 237 with the bottom portion 235. At least a portion of the cover 101 can enter the receiving space 237. The main body 201 includes a working area 205 and a linkage mating area 216, shown in dashed lines in FIG. 2A. The working area 205 is located at the bottom portion 235 of the main body 201, and the working area 205 can be aligned with an area where the charging port or the fueling port of the vehicle is located. In this embodiment, the working area 205 includes working openings 252 and 253. The working openings 252 and 253 pass through the bottom portion 235 for mounting the charging port or the fueling port. In another embodiment of the present disclosure, the working area 205 is a hollowed-out area which is aligned with the area where the charging port or the fueling port of the vehicle is located. The linkage mating area 216 is located at one side of the working area 205 and at the connection of the side edge 236 and the bottom portion 235. The linkage mating area 216 has a linkage opening 226, and the linkage mechanism 103 passes through the linkage opening 226 and can move within the linkage opening 226. The linkage opening 226 has an inside edge 260. The inside edge 260 extends smoothly in the width direction W1 of the charging port or fueling port cover assembly. In other embodiments of the present disclosure, the linkage mating area 216 is located at the bottom portion 235 or the side edge 236, or at the side portion 202. A mounting structure 250 is provided at the rear side of the main body 201 for connection with the interior of the vehicle. The working area 205 has a first side 241 and a second side 242 in the first direction. The first side 241 is located upstream of the second side 242 in a direction of moving the cover 101 from the closed position to the open position. The linkage mating area 216 and the working area 205 are arranged along the first direction, and the linkage mating area 216 is proximate to the second side 242. In an embodiment of the present disclosure, the linkage mating area 216 is located downstream of the working area 205 in the direction of moving the cover 101 from the closed position to the open position.

In the present disclosure, the working area 205 is an area capable of mating with or being aligned with the charging port or the fueling port, is not limited to a specific component of the housing 102, and may include a non-physical part. In some embodiments, the working area 205 is provided with an opening exactly at the charging port or the fueling port. In some other embodiments, the working area 205 is only a reserved mounting space, and is not provided with a physical structure. Similarly, the linkage mating area 216 is an area through which the linkage mechanism 103 can pass, and the linkage mating area 216 is provided with an opening matching the shape of the linkage mechanism, or is a hollowed-out area within which the linkage mechanism 103 can move.

The main body 201 further includes a limiting portion 288. The limiting portion 288 is an opening passing through the bottom portion 235, and the limiting portion 288 can mate with the cover 101 to snap-fit the cover 101 to the housing 102.

As shown in FIGS. 2A and 2B, the side portion 202 is connected to the linkage mating area 216 and is arranged at one side of the working area 205. The side portion 202 includes a linkage receiving area 207 having a linkage receiving space 271 for receiving the linkage mechanism 103. The linkage receiving space 271 is in communication with the linkage opening 226. The linkage receiving area 207 does not overlap with the working area 205 in the first direction. The side portion 202 further includes a power device mounting portion 290 for mounting the power device 104. It should be noted that the linkage receiving area 207 includes a semi-open receiving space. In the present disclosure, when the linkage mechanism 103 enters the linkage receiving area 207, the linkage mechanism 103 is allowed to extend beyond the edge of the housing 102 at the linkage receiving area 207.

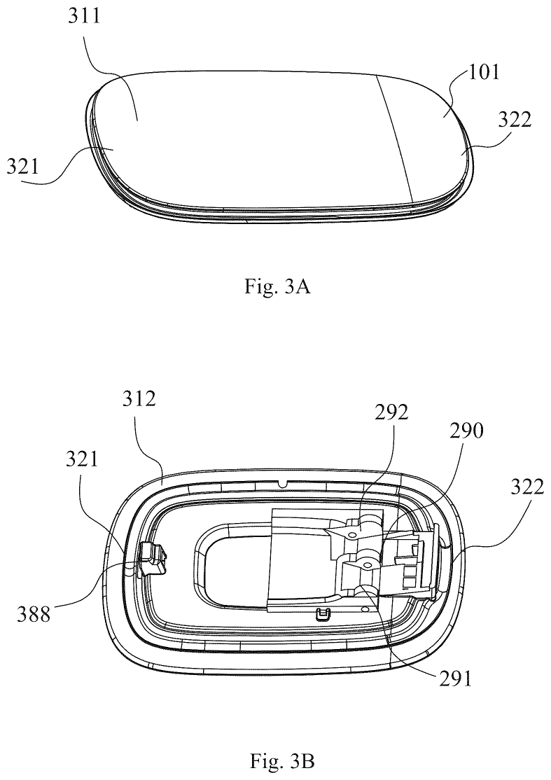

FIG. 3A is a perspective view of the cover of FIG. 1B, and FIG. 3B is a perspective view of the cover of FIG. 3A from another angle. FIGS. 3A and 3B show the front and back of the cover 101.

As shown in FIGS. 3A and 3B, the cover 101 is substantially flat plate-shaped and has a front side 311 and a rear side 312. The front side 311 is arranged toward the exterior of the vehicle, and the rear side 312 is arranged toward the housing 102. The cover 101 has a first side portion 321 and a second side portion 322 in the first direction. In the closed position of the cover 101, the first side portion 321 is proximate to the first side 241 of the working area, and the second side portion 322 is proximate to the second side 242 of the working area. That is, the first side portion 321 is located upstream of the second side portion 322 in the direction of moving the cover 101 from the closed position to the open position.

The rear side 312 of the cover 101 has a connecting portion 290. The connecting portion 290 is proximate to the second side portion 322. The connecting portion 290 includes a first linkage mounting portion 291 and a second linkage mounting portion 292. The first linkage mounting portion 291 and the second linkage mounting portion 292 are configured to mount a pair of shafts in the shaft assembly 170, respectively. The first linkage mounting portion 291 and the second linkage mounting portion 292 are staggered so that the two shafts in the shaft assembly 170 are arranged non-coaxially.

The cover 101 further includes a protrusion 388. The protrusion 388 protrudes from a surface of the rear side 312 and is proximate to the first side portion 321. The protrusion 388 can enter the limiting portion 288 of the housing 102 so that the cover 101 is not easily moved relative to the housing 102 along an extension direction of the cover 101 in the closed position.

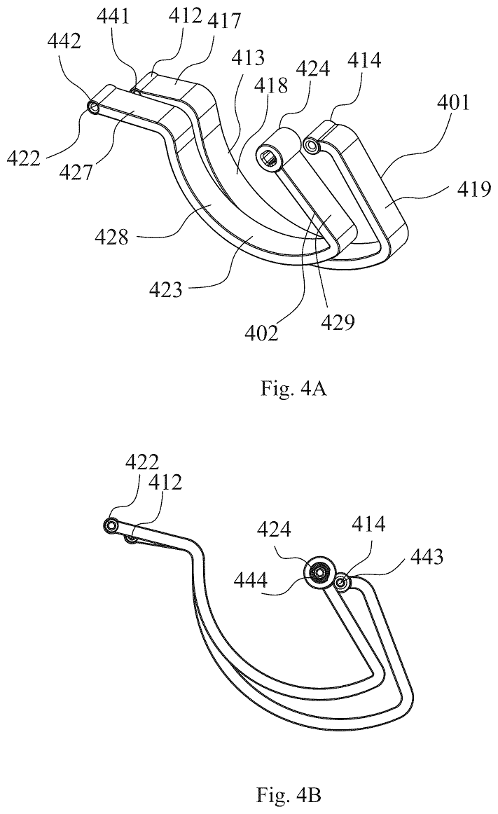

FIG. 4A is a perspective view of the linkage mechanism of FIG. 1B, and FIG. 4B is a side view of the linkage mechanism of FIG. 4A. FIGS. 4A and 4B show the structure of the linkage mechanism.

As shown in FIGS. 4A and 4B, the linkage mechanism 103 includes a first connecting rod 401 and a second connecting rod 402. The first connecting rod 401 and the second connecting rod 402 have similar but different shapes. In this embodiment, that first bar 401 and the second bar 402 are staggered. As viewed from the side, the first connecting rod 401 and the second connecting rod 402 do not overlap with each other.

The first connecting rod 401 includes a first upper connecting portion 412, a first gooseneck portion 413 and a first lower connecting portion 414. The first upper connecting portion 412 has a shaft mounting hole 441, so that the first upper connecting portion 412 can be hinged to the first linkage mounting portion 291 of the cover 101 via a shaft. The first lower connecting portion 414 has a shaft mounting hole 443, so that the first lower connecting portion 414 can be hinged to the housing 102 via a shaft. The first gooseneck portion 413 includes a first upper smooth section 417, a first curved section 418 and a first lower smooth section 419. The first upper smooth section 417, the first curved section 418 and the first lower smooth section 419 are connected to one another in sequence. The first curved section 418 is substantially in the shape of a circular arc, and an outer surface of the first curved section 418 forms a first circular arc. The first upper smooth section 417 extends from one end of the first curved section 418 in a direction away from a center of circle of the first circular arc. The first lower smooth section 419 extends from one end of the first curved section 418 in a direction proximate to the center of circle of the first circular arc. The first lower connecting portion 414 coincides with the center of circle of the first circular arc. The first lower connecting portion 414 is hinged to the housing 102 via a connecting shaft.

Similarly, the second connecting rod 402 includes a second upper connecting portion 422, a second gooseneck portion 423 and a second lower connecting portion 424. The second upper connecting portion 422 has a shaft mounting hole 442, and the second upper connecting portion 422 is hinged to the second linkage mounting portion 292 of the cover 101 via a shaft. The second lower connecting portion 424 has a shaft mounting hole 444, and the shaft mounting hole 444 has an anti-rotation shape, so that the second lower connecting portion 424 can be fixedly connected to the power device 104 via a shaft. The second gooseneck portion 423 includes a second upper smooth section 427, a second curved section 428 and a second lower smooth section 429. The second upper smooth section 427, the second curved section 428 and the second lower smooth section 429 are connected to one another in sequence. The second curved section 428 is substantially in the shape of a circular arc, and an outer surface of the second curved section 428 forms a second circular arc. The second upper smooth section 427 extends from one end of the second curved section 428 in a direction away from a center of circle of the second circular arc. The second lower smooth section 429 extends from one end of the second curved section 428 in a direction proximate to the center of circle of the second circular arc. The second lower connecting portion 424 coincides with the center of circle of the second circular arc.

As shown in FIG. 4B, a connecting shaft for connecting the first upper connecting portion 412 and the cover 101 and a connecting shaft for connecting the second upper connecting portion 422 and the cover 101 are arranged non-coaxially. That is, the shaft mounting holes 441 and 442 are arranged non-coaxially. A connecting shaft for connecting the first lower connecting portion 414 and the housing 102 and a connecting shaft for connecting the second lower connecting portion 424 and the power device 104 are arranged non-coaxially. In the first direction, there is a spacing between the connecting shaft for connecting the first upper connecting portion 412 and the cover 101 and the connecting shaft for connecting the second upper connecting portion 422 and the cover 101, and there is a spacing between the connecting shaft for connecting the first lower connecting portion 414 and the housing 102 and the connecting shaft for connecting the second lower connecting portion 424 and the power device 104. In this embodiment, the first circular arc and the second circular arc have different diameters, and the first circular arc and the second circular arc do not coincide with each other.

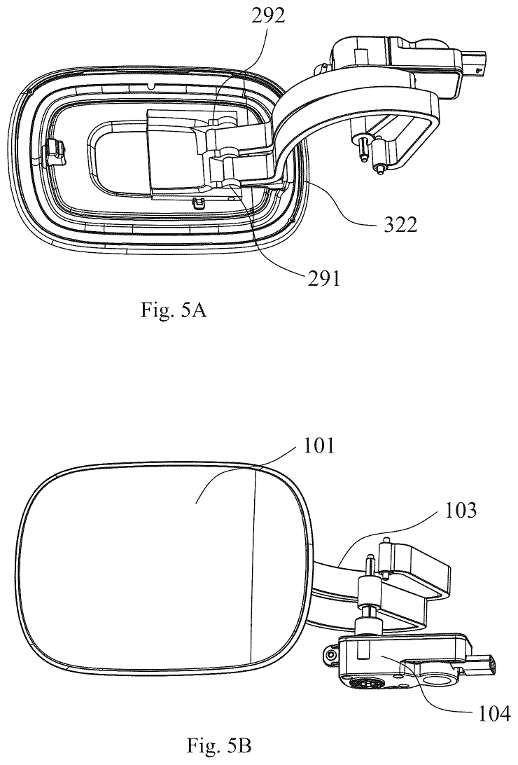

FIG. 5A is a perspective view of the charging port or fueling port cover assembly of FIG. 1A with the housing hidden, and FIG. 5B is a perspective view of the charging port or fueling port cover assembly of FIG. 5A with the housing hidden from another angle. FIGS. 5A and 5B show the mating relationship of the linkage mechanism with the cover and power device.

As shown in FIG. 5A, the first connecting rod 401 is hinged to the first linkage mounting portion 291 of the cover 101 via a connecting shaft, and the second connecting rod 402 is hinged to the second linkage mounting portion 292 of the cover 101 via a connecting shaft. The connection of the first connecting rod 401 and the second connecting rod 402 to the cover 101 is proximate to the second side portion 322 of the cover 101.

As shown in FIG. 5B, one end of the second connecting rod 402 is hinged to the cover 101, and the other end of the second connecting rod 402 is fixedly connected to the power device 104 via a connecting shaft, so that the power device 104 can rotate the second connecting rod 402 via the connecting shaft. The two ends of the first connecting rod 401 are connected to the cover 101 and the housing 102, respectively, and when the second connecting rod 402 is driven to rotate, the first connecting rod 401 rotates along with the second connecting rod 402. During the movement of the linkage mechanism 103, the first connecting rod 401 and the second connecting rod 402 do not coincide with each other so that the cover 101 can move translationally relative to the housing 102.

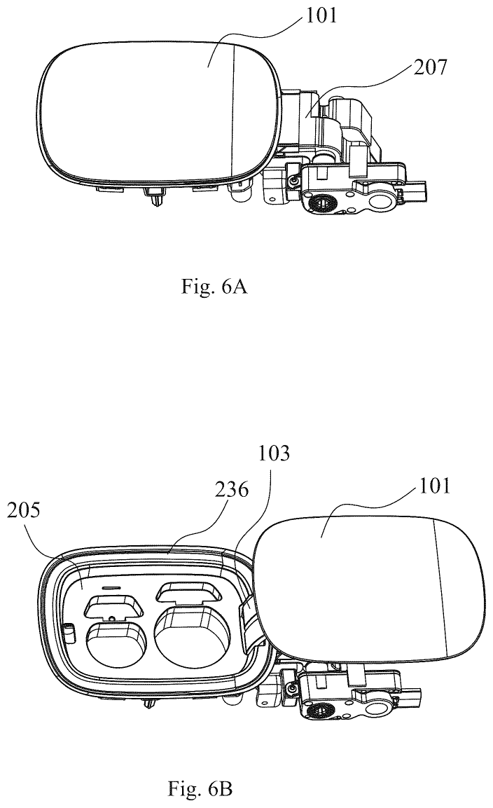

FIG. 6A is a perspective view of the charging port or fueling port cover assembly of FIG. 1A with the cover in the closed position, and FIG. 6B is a perspective view of the charging port or fueling port cover assembly of FIG. 1A with the cover in the open position. FIGS. 6A and 6B show a working process of the cover of the charging port or fueling port cover assembly.

As shown in FIG. 6A, when the cover 101 is in the closed position, the cover 101 covers the housing 102, thereby shielding the working area 205 of the housing 102. An outer surface of the cover 101 is substantially flush with the side edge 236 of the housing 102, or is slightly higher than the side edge 236. As shown in FIG. 6B, when the cover 101 is in the open position, the cover 101 moves away from the housing 102, so as to expose the working area 205. The cover 101 is located at one side of the working area 205 in the first direction and is located above the linkage receiving area 207 in the height direction of the charging port or fueling port cover assembly. As viewed in the height direction, most of the linkage mechanism 103 is shielded by the cover 101, and an operator cannot easily see the linkage mechanism, making the charging port or fueling port cover assembly in the present disclosure neat and aesthetically pleasing.

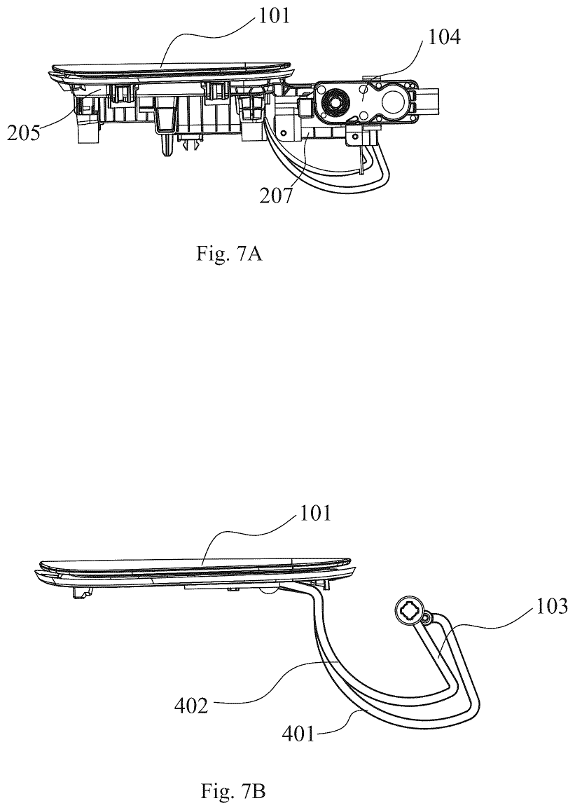

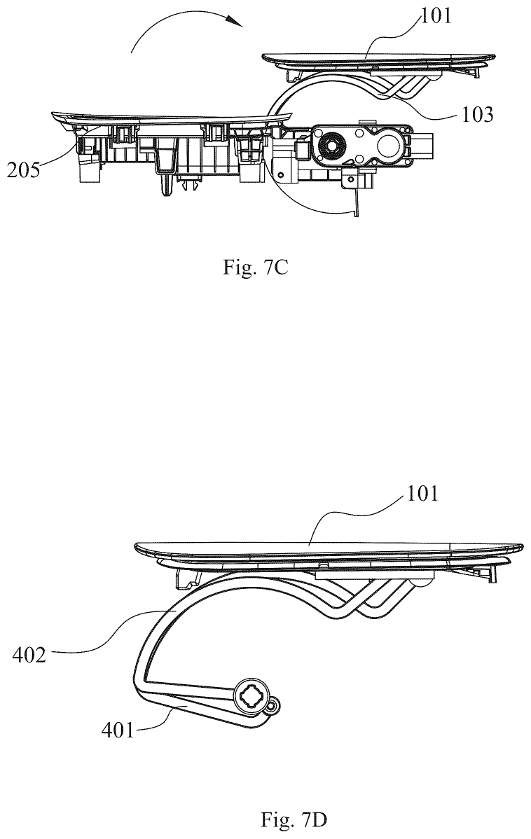

FIG. 7A is a side view of the charging port or fueling port cover assembly of FIG. 6A, FIG. 7B is a side view of the charging port or fueling port cover assembly of FIG. 6A with the housing hidden, FIG. 7C is a side view of the charging port or fueling port cover assembly of FIG. 6B, and FIG. 7D is a side view of the charging port or fueling port cover assembly of FIG. 6B with the housing hidden.

As shown in FIGS. 7A and 7B, when the cover 101 is in the closed position, the cover 101 covers the housing 102, and most of the linkage mechanism 103 is aligned with the linkage receiving area 207 in the first direction. The linkage receiving area 207 is located at one side of the working area 205 of the housing 102.

When the cover 101 needs to be opened, the power device 104 drives the second connecting rod 402 of the linkage mechanism 103 to rotate, and the second connecting rod 402 is rotated in the direction (i.e. clockwise) indicated by the arrow in FIG. 7C. The second upper connecting portion 422 of the second connecting rod 402 is hinged to the cover 101, so that the second upper connecting portion 422 rotates relative to the cover 101 and drives the cover 101 to move. The first connecting rod 401 is hinged to the cover 101 and the housing 102, respectively, and the first upper connecting portion 412 and the first lower connecting portion 414 of the first connecting rod 401 are arranged non-coaxially with the second upper connecting portion 422 and the second lower connecting portion 424 of the second connecting rod 402, respectively, so that the first connecting rod 401 and the second connecting rod 402 can jointly support the translational movement of the cover 101 thereby the cover 101 does not rotate relative to the housing 102 during the movement. A hinge point between the first connecting rod 401 and the housing 102 enables the first connecting rod 401 to move along with the second connecting rod 402 via the cover 101 without being stuck. In this embodiment, that first connecting rod 401 and the second connecting rod 402 are similar but not identical in shape, to enable the cover 101 to move translationally.

When the cover 101 moves between the open position and the closed position, the first curved section 418 of the first connecting rod 401 and the second curved section 428 of the second connecting rod 402 have different diameters, so that the movement trajectories do not coincide with each other. The first connecting rod 401 and the second connecting rod 402 are shaped such that at the inside edge 260 of the linkage opening 226, respective outside surfaces (i.e., surfaces facing the inside edge 260) of the first curved section 418 and the second curved section 428 coincide with each other. In this way, the inside edge 260 may be configured to have a smoothly extending shape to match the movement trajectories of the first curved section 418 and the second curved section 428 at the linkage opening 226.

During the movement of the cover 101, the movement trajectories of the first curved section 418, the second curved section 728, the first lower smooth section 419 and the second lower smooth section 429 of the linkage mechanism 103 are all located at one side of the working area 205. When the cover 101 is in the closed position and the open position, the first curved section 418, the second curved section 728, the first lower smooth section 419 and the second lower smooth section 429 are aligned with the linkage receiving area 207 in the first direction, and are located at one side of the working area. That is, the first curved section 418, the second curved section 728, the first lower smooth section 419 and the second lower smooth section 429 of the linkage mechanism 103 are all staggered with the working area 205 during rest and movement. In this way, in the working area 205, there is no need to provide a large receiving space for the linkage mechanism 103, so that the housing 102 has a small thickness in the working area 205, and is suitable for a small mounting space. Moreover, in the open position of the cover 101, when the operator looks toward the housing 102, the working area 205 of the housing 102 is simple and neat.

As the cover 101 moves between the open position and the closed position, the cover 101 moves translationally relative to the housing 102. In the open position of the cover 101, a plane where the cover 101 is located is substantially parallel to a plane where a top portion of the side edge 236 of the housing 102 is located. During the movement of the cover 101, each part of the cover 101 moves by an equal distance relative to the corresponding part of the housing 102, and the cover 101 cannot be flipped relative to the housing 102. The movement trajectory of the cover 101 is arc-shaped, that is, the movement trajectory of each part of the cover 101 is arc-shaped.

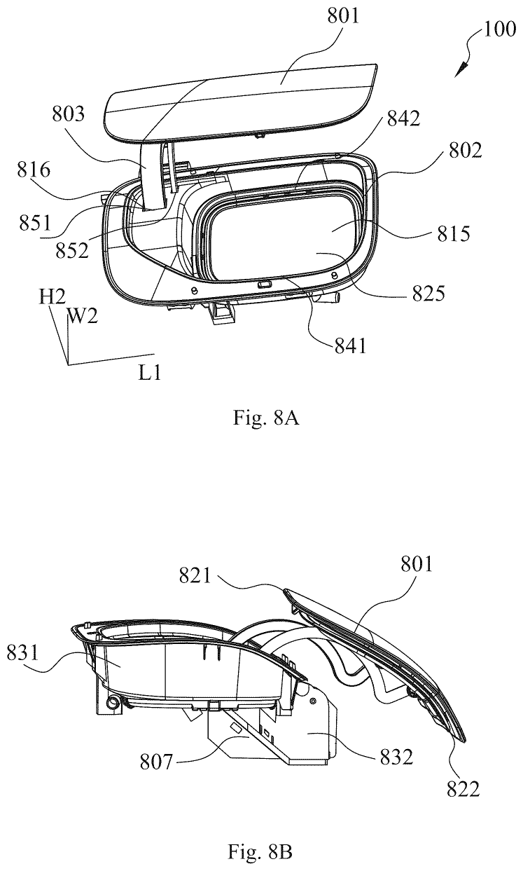

FIG. 8A is a perspective view of a charging port or fueling port cover assembly according to a second embodiment of the present disclosure, and FIG. 8B is a perspective view of the charging port or fueling port cover assembly of FIG. 8A from another angle. The embodiment shown in FIG. 8A is similar to the embodiment shown in FIG. 2A, except that the positions of the working area and the linkage mating area of the cover of the charging port or fueling port cover assembly in FIG. 8A are arranged differently.

As shown in FIGS. 8A and 8B, the charging port or fueling port cover assembly 800 includes a housing 802, a cover 801, a linkage mechanism 803, and a power device (not shown). The charging port or fueling port cover assembly 800 has a height direction H2, a length direction L2, and a width direction W2. During the movement of the cover 801 relative to the housing 802 between the closed position and the open position, the cover 801 translates relative to the housing 802 in the height direction H2 and in the width direction W1. That is, during the movement of the cover 801 between the open position and the closed position, each part of the cover is moved by an equal distance relative to the corresponding part of the housing 802. In this embodiment, the width direction W1 is defined as a first direction.

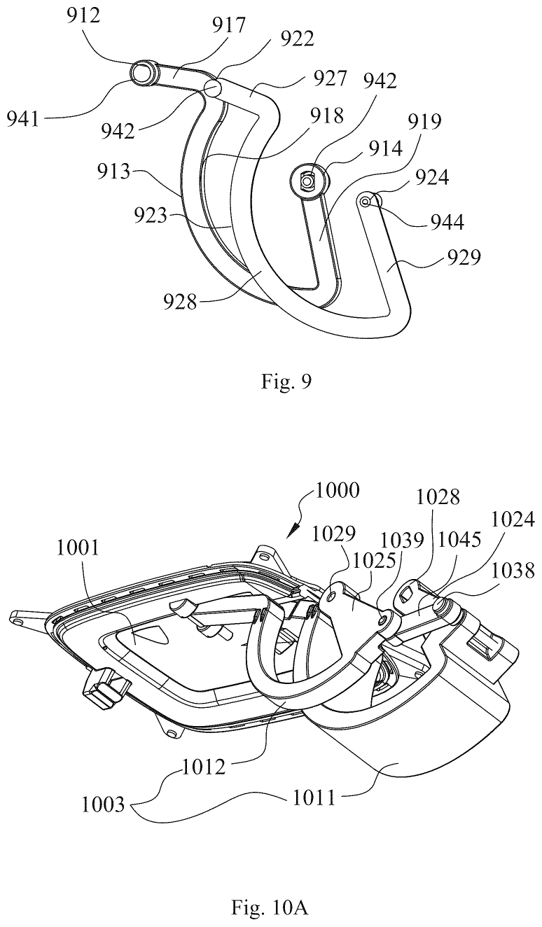

The linkage mechanism 803 includes a first connecting rod 901 and a second connecting rod 902 (see FIG. 9). The housing 802 includes a main body 831 and a side portion 832. The side portion 832 includes a linkage receiving area 807. The main body 831 has a working area 815 and a linkage mating area 816. The working area 815 has a hollowed-out opening 825 which can mate with the charging port or the fueling port of the vehicle. The linkage mating area 816 includes a pair of linkage openings 851 and 852. The first connecting rod 901 and the second connecting rod 902 can pass through the linkage openings 851 and 852, respectively, and move within the linkage openings 851 and 852, respectively. The working area 815 and the linkage mating area 816 are arranged in the length direction L2 of the charging port or fueling port cover assembly 800. In the width direction W1 (i.e. in the first direction), the working area has a first side 841 and a second side 842. The first side 841 is located upstream of the second side 842 in the direction of moving the cover 801 from the closed position to the open position. The linkage mating area 816 is proximate to the second side 842 in the width direction W2 of the charging port or fueling port cover assembly 800. The linkage receiving area 807 is connected to the linkage mating area 816 and extends along the width direction W2 in a direction away from the first side of the working area 815.

The cover 801 has a first side portion 821 and a second side portion 822 in the first direction. That is, the first side portion 821 is located upstream of the second side portion 822 in the direction of moving the cover 801 from the closed position to the open position. The connection of the linkage mechanism 803 and the cover 801 is proximate to the second side portion 822.

Similar to the embodiment shown in FIG. 2A, in the working area 815, there is no need to provide a large receiving space for the linkage mechanism 803, so that the housing 802 has a small thickness in the working area 805, and is suitable for a small mounting space. Moreover, in the open position of the cover 801, when the operator looks toward the housing 802, the working area 815 of the housing 802 is simple and neat.

FIG. 9 is a side view of the linkage mechanism of FIG. 8A. As shown in FIG. 9, the linkage mechanism 803 includes a first connecting rod 901 and a second connecting rod 902. In this embodiment, the first connecting rod 901 and the second connecting rod 902 have the same shape. The first connecting rod 901 includes a first upper connecting portion 912, a first gooseneck portion 913 and a first lower connecting portion 914. The first upper connecting portion 912 has a shaft mounting hole 941, so that the first upper connecting portion 912 can be hinged to the cover 801 via a shaft. The first lower connecting portion 914 has a shaft mounting hole 942, so that the first lower connecting portion 914 can be fixedly connected to the power device via a shaft. The first gooseneck portion 913 includes a first upper smooth section 917, a first curved section 918 and a first lower smooth section 919. The first upper smooth section 917, the first curved section 918 and the first lower smooth section 919 are connected to one another in sequence. The first curved section 918 is substantially in the shape of a circular arc. The first upper smooth section 917 extends from one end of the first curved section 918 in a direction away from a center of circle of the first circular arc. The first lower smooth section 919 extends from one end of the first curved section 918 in a direction proximate to the center of circle of the first circular arc. The first lower connecting portion 914 coincides with the center of circle of the first circular arc. The first lower connecting portion 914 is hinged to the housing 802 via a connecting shaft.

Similarly, the second connecting rod 902 includes a second upper connecting portion 922, a second gooseneck portion 923 and a second lower connecting portion 924. The second upper connecting portion 922 has a shaft mounting hole 943, and the second upper connecting portion 922 is hinged to the cover 801 via a shaft. The second lower connecting portion 924 has a shaft mounting hole 944, so that the second lower connecting portion 924 can be hinged to the housing 802 via a shaft. The second gooseneck portion 923 includes a second upper smooth section 927, a second curved section 928 and a second lower smooth section 929. The second upper smooth section 927, the second curved section 928 and the second lower smooth section 929 are connected to one another in sequence. The second curved section 928 is substantially in the shape of a circular arc. The second upper smooth section 927 extends from one end of the second curved section 928 in a direction away from a center of circle of the second circular arc. The second lower smooth section 929 extends from one end of the second curved section 928 in a direction proximate to the center of circle of the second circular arc. The second lower connecting portion 924 coincides with the center of circle of the second circular arc.

Referring to FIG. 9, the first connecting rod 901 and the second connecting rod 902 are staggered so that the shaft mounting hole 941 of the first upper connecting portion 912 and the shaft mounting hole 943 of the second upper connecting portion 422 are arranged non-coaxially, and the shaft mounting hole 942 of the first lower connecting portion 914 and the shaft mounting hole 944 of the second lower connecting portion 924 are arranged non-coaxially. In the first direction, there is a spacing between the shaft mounting hole 941 of the first upper connecting portion 912 and the shaft mounting hole 943 of the second upper connecting portion 422, and there is a spacing between the shaft mounting hole 942 of the first lower connecting portion 914 and the shaft mounting hole 944 of the second lower connecting portion 924. That is, in this embodiment, the first connecting rod 901 and the second connecting rod 902 have the same shape, but are staggered in the first direction, and the linkage mechanism 803 can also drive the cover 801 to move translationally relative to the housing 802.

In this embodiment, the linkage mating area 816 is arranged proximate to the second side 842 of the working area 815, and the linkage receiving area 807 extends from the linkage mating area 816 in a direction away from the first side 841 of the working area 815. That is, in the first direction, at least a part of the linkage receiving area 807 is staggered with the working area 805. In this way, the thickness of the working area 805 can be set small, and the working area 805 is neat and aesthetically pleasing. The embodiment of FIG. 8A enables similar technical effects to the embodiment of FIG. 1A.

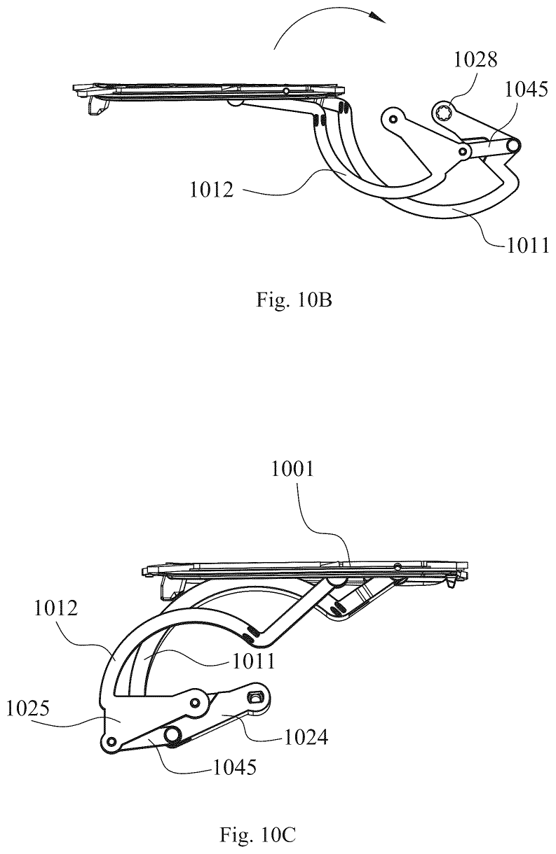

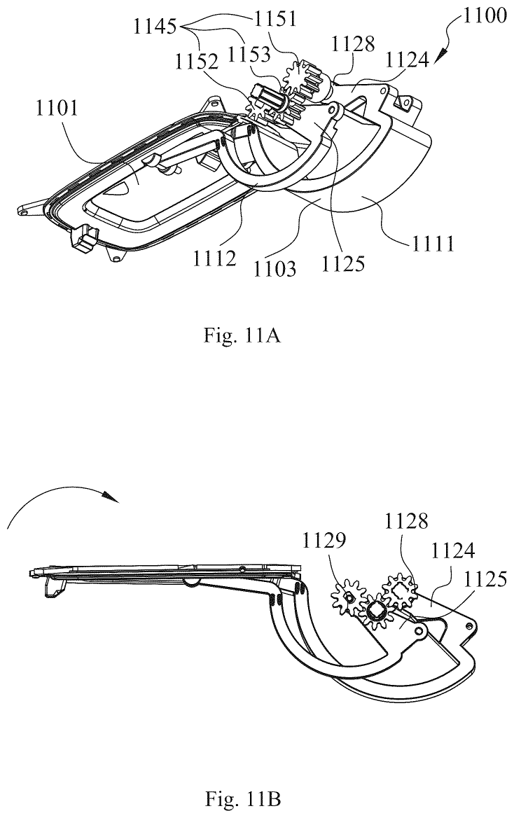

FIG. 10A is a perspective view of a charging port or fueling port cover assembly according to a third embodiment of the present disclosure with a housing omitted, FIG. 10B is a side view of a linkage mechanism and a cover of FIG. 10A with the cover in a closed position, and FIG. 10C is a side view of the linkage mechanism and the cover of FIG. 10A with the cover in an open position.

The third embodiment shown in FIGS. 10A-10C is similar to the first embodiment shown in FIG. 1A, except that the third embodiment shown in FIGS. 10A-10C further includes a transmission device. As shown in FIGS. 10A and 10C, the charging port or fueling port cover assembly 1000 includes a cover 1001 and a linkage mechanism 1003. One end of the linkage mechanism 1003 is connected to the cover 1001. The linkage mechanism 1003 includes a first connecting rod 1011, a second connecting rod 1012, and a connecting member 1045. The connecting member 1045 is rod-shaped, and its two ends are pivotally connected to the first connecting rod 1011 and the second connecting rod 1012 via a shaft 1038 and a shaft 1039, respectively. The shaft 1038 is located at a first lower connecting portion 1024 of the first connecting rod 1011, and the shaft 1039 is located at a second lower connecting portion 1025 of the second connecting rod 1012. That is, the shaft 1038 is located at a part of the first connecting rod 1011 away from the cover 1001, and the shaft 1039 is located at a part of the second connecting rod 1012 away from the cover 1001. In this embodiment, a distal end 1028 of the first lower connecting portion 1024 is connected to a power device (not shown) via a shaft, and a distal end 1029 of the second lower connecting portion 1025 is pivotally connected to the housing via a shaft. In one embodiment of the present disclosure, respective proximal ends of the first lower connecting portion 1024 and the second lower connecting portion 1025, that is, the connections of the connecting member 1045, have a larger width.

When the power device rotates, the power device drives the first connecting rod 1011 to rotate around the distal end 1028 of the first lower connecting portion 1024. When the first connecting rod 1011 rotates, the second connecting rod 1012 is driven by means of the connecting member 1045 to rotate around the distal end 1029 of the second lower connecting portion 1025. The connecting member 1045 is arranged at the first lower connecting portion 1024 and the second lower connecting portion 1025, proximate to centers of rotation of the first connecting rod 1011 and the second connecting rod 1012, to facilitate the transmission of the rotational movement of the first connecting rod 1011 to the second connecting rod 1012 as soon as possible, such that the first connecting rod 1011 and the second connecting rod 1012 rotate together.

FIG. 10B shows the closed position of the cover, and FIG. 10C shows the open position of the cover. A driving device drives the first connecting rod 1011 to rotate in a clockwise direction as indicated by the arrow during movement of the cover from the closed position to the open position, and the first connecting rod 1011 drives the connecting member 1045 to rotate, which in turn drives the second connecting rod 1012 to rotate. Thus, the second connecting rod 1012 and the first connecting rod 1011 rotate together in the direction of the arrow, and the cover 1001 is opened. The driving device drives the first connecting rod 1011 to rotate in a counterclockwise direction as indicated by the arrow during movement of the cover from the open position to the closed position, the first connecting rod 1011 drives the connecting member 1045 to rotate, which in turn drives the second connecting rod 1012 to rotate, so that the cover is returned from the position shown in FIG. 10C to the position shown in FIG. 10B.

Compared with the embodiment shown in FIG. 1A, in this embodiment, the rotational movement of the first connecting rod 1011 is transmitted through the connecting member 1045, rather than the rotational movement of the first connecting rod 1011 being transmitted through the cover 1001. The connecting member 1045 in this embodiment is arranged proximate to rotation axes of the first connecting rod 1011 and the second connecting rod 1012, to facilitate the synchronous movement of the first connecting rod 1011 and the second connecting rod 1012 as soon as possible. This avoids the possibility of vibration of the second connecting rod 1012 and the first connecting rod 1011 due to slight deformation during the movement, as a conduction path of the rotational motion is too long. At the same time, the connecting member 1045 is positioned such that the connecting member 1045 is hidden in the housing during the movement of opening or closing the cover, making the appearance of the charging port or fueling port cover assembly neat and aesthetically pleasing.

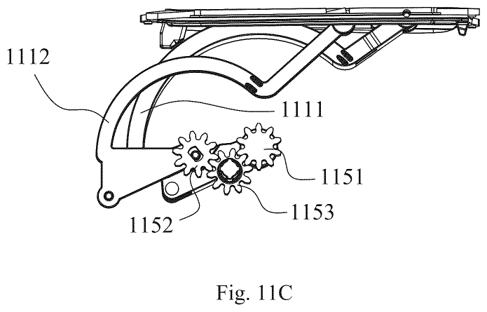

FIG. 11A is a perspective view of a charging port or fueling port cover assembly according to a fourth embodiment of the present disclosure with a housing omitted, FIG. 11B is a side view of a linkage mechanism and a cover of FIG. 11A with the cover in a closed position, and FIG. 11C is a side view of the linkage mechanism and the cover of FIG. 11A with the cover in an open position.

The fourth embodiment shown in FIGS. 11A-11C is similar to the first embodiment shown in FIG. 10A, except that the transmission device in the fourth embodiment shown in FIGS. 11A-11C is a gear set. As shown in FIGS. 11A and 11C, the charging port or fueling port cover assembly 1100 includes a cover 1101 and a linkage mechanism 1103. One end of the linkage mechanism 1103 is connected to the cover 1101. The linkage mechanism 1103 includes a first connecting rod 1111, a second connecting rod 1112, and a gear set 1145. The gear set 1145 includes a first gear 1151, a second gear 1152, and a third gear 1153.

The first gear 1151 is fixedly connected to the first connecting rod 1111, and the second gear 1152 is fixedly connected to the second connecting rod 1112. The first gear 1151 moves synchronously with the first connecting rod 1111, and the second gear 1152 moves synchronously with the second connecting rod 1112. The connection of the first gear 1151 and the first connecting rod 1111 is located at a distal end 1128 of a first lower connecting portion 1124 and is approximately located on an axis of rotation of the first connecting rod 1111 relative to the housing. The connection of the second gear 1152 and the second connecting rod 1112 is located at a distal end 1129 of a second lower connecting portion 1125 and is approximately located on an axis of rotation of the second connecting rod 1112 relative to the housing. That is, the first gear 1151 is located at a part of the first connecting rod 1111 away from the cover 1101, and the second gear 1152 is located at a part of the second connecting rod 1112 away from the cover 1101. The third gear 1153 is located between the first gear 1151 and the second gear 1152. The third gear 1153 is pivotally connected to the housing and meshes with the first gear 1151 and the second gear 1152, to enable the rotational movement of the first gear 1151 to be transmitted to the second gear 1152.

In this embodiment, the distal end 1128 of the first lower connecting portion 1124 is connected to a power device (not shown) via a shaft, and the distal end 1129 of the second lower connecting portion 1125 is pivotally connected to the housing via a shaft.

When the power device rotates, the power device drives the first connecting rod 1111 to rotate around the distal end 1128 of the first lower connecting portion 1124. When the first connecting rod 1111 rotates, the first gear 1151 rotates synchronously. The first gear 1151 drives the third gear 1153 to rotate, and the third gear 1153 drives the second gear 1152 to rotate. The second gear 1152 is fixedly connected to the second connecting rod 1112 so that the second connecting rod 1112 and the second gear 1152 rotate together. That is, the rotational movement of the first connecting rod 1111 is transmitted through the gear set 1145 to the second connecting rod 1112. The gear set 1145 is arranged at the distal end 1128 of the first lower connecting portion 1124 and the distal end 1129 of the second lower connecting portion 1125, facilitating the transmission of the movement of the first connecting rod 1111 to the second connecting rod 1112 as soon as possible, so that the first connecting rod 1111 and the second connecting rod 1112 rotate together.

FIG. 11B shows the closed position of the cover, and FIG. 11C shows the open position of the cover. A driving device drives the first connecting rod 1111 to rotate in a clockwise direction as indicated by the arrow during movement of the cover from the closed position to the open position, the first gear 1151 fixedly connected to the first connecting rod 1111 rotates in the clockwise direction, the third gear 1153 meshing with the first gear 1151 rotates in a counterclockwise direction, and the second gear 1152 meshing with the third gear 1153 rotates in the clockwise direction, so that the second connecting rod 1112, which is fixedly connected to the second gear, rotates in the clockwise direction. The first connecting rod 1111 and the second connecting rod 1112 rotate together to move the cover 1101 to the open position. When it is necessary to close the cover 1101, the driving device drives the first connecting rod 1111 to rotate in the counterclockwise direction, to return from the open position to the closed position.

Compared with the embodiment shown in FIG. 10A, the rotational movement of the first connecting rod 1111 is transmitted through the gear set 1045 in this embodiment, and the same technical effect as the embodiment in FIG. 10A can be achieved. In an embodiment, the third gear of the gear set 1045 may be a plurality of gears, as long as the plurality of gears can mesh with each other to transmit the rotational motion of the first gear 1151 to the second gear 1152.

In the present disclosure, the transmission device is made of a rigid member, has a high strength and is not susceptible to elastic deformation. This ensures maximum transmission smoothness, which makes the assembly system less susceptible to vibration during opening or closing of the cover.

In the present disclosure, the transmission device may also be other device capable of transmitting the rotational movement of the first connecting rod to the second connecting rod.

In another embodiment of the present disclosure, the first connecting rod and the second connecting rod are made of a material of high strength, such as metal, or by a metal insert injection molding process. Where no transmission device is provided, the first connecting rod and the second connecting rod are not easily deformed during rotation, so that the linkage mechanism and the cover are not easily vibrated during opening or closing of the cover.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A charging port or fueling port cover assembly, comprising:
a housing having a working area and a linkage mating area;
a cover movable relative to the housing and having an open position and a closed position, the cover covering the working area in the closed position and exposing the working area in the open position; and
a linkage mechanism passing through the linkage mating area to be connected to the cover, the linkage mechanism being movable in the linkage mating area to drive the cover to move between the open position and the closed position,
wherein the cover is configured to be translatable from one to the other of the open position and the closed position.

2. The charging port or fueling port cover assembly of claim 1, wherein
the linkage mechanism comprises a first connecting rod and a second connecting rod, the first connecting rod and the second connecting rod being staggered.

3. The charging port or fueling port cover assembly of claim 2, wherein
the housing comprises a linkage receiving area connected to the linkage mating area, and at least a portion of each of the first connecting rod and the second connecting rod is capable of entering the linkage receiving area when the cover is in the closed position.

4. The charging port or fueling port cover assembly of claim 2, wherein
the first connecting rod comprises a first upper connecting portion, a first gooseneck portion and a first lower connecting portion, the first upper connecting portion being hinged to the cover;
the second connecting rod comprises a second upper connecting portion, a second gooseneck portion and a second lower connecting portion, the second upper connecting portion being hinged to the cover;
at least one of the first lower connecting portion and the second lower connecting portion is connected to a power device; and
a connecting shaft for the first upper connecting portion and the cover and a connecting shaft for the second upper connecting portion and the cover are arranged non-coaxially.

5. The charging port or fueling port cover assembly of claim 4, wherein
the first gooseneck portion and the second gooseneck portion comprise a first curved section and a second curved section, respectively, an outer surface of the first curved section forming a first circular arc, an outer surface of the second curved section forming a second circular arc, the first lower connecting portion coinciding with a center of circle of the first circular arc, the second lower connecting portion coinciding with a center of circle of the second circular arc, and a connecting shaft for the first lower connecting portion and a connecting shaft for the second lower connecting portion are arranged non-coaxially;
the first gooseneck portion comprises a first upper smooth section and a first lower smooth section, and the second gooseneck portion comprises a second upper smooth section and a second lower smooth section, the first upper smooth section extending from one end of the first curved section in a direction away from the center of circle of the first circular arc, the second upper smooth section extending from one end of the second curved section in a direction away from the center of circle of the second circular arc; and the first lower smooth section extending from one end of the first curved section in a direction proximate to the center of circle of the first circular arc, and the second lower smooth section extending from one end of the second curved section in a direction proximate to the center of circle of the second circular arc.

6. The charging port or fueling port cover assembly of claim 5, wherein
during movement of the cover between the open position and the closed position, the first curved section, the second curved section, the first lower smooth section and the second lower smooth section are all located upstream or downstream of the working area in a movement direction of the cover.

7. The charging port or fueling port cover assembly of claim 4, further comprising:
a power device, wherein one of the first lower connecting portion and the second lower connecting portion is connected to the power device and is configured to be driven by the power device to rotate, so as to drive the corresponding connecting rod to rotate, and the other thereof is hinged to the housing.

8. The charging port or fueling port cover assembly of claim 1, wherein
the linkage mating area is arranged upstream or downstream of the working area in a movement direction of the cover.

9. The charging port or fueling port cover assembly of claim 4, wherein
the linkage mating area comprises at least one linkage opening penetrating the housing, the linkage opening having an inside edge proximate to the working area, and the inside edge extending smoothly.

10. The charging port or fueling port cover assembly of claim 9, wherein
at the linkage opening, an outer surface of the first curved section coincides with an outer surface of the second curved section.

11. The charging port or fueling port cover assembly of claim 4, wherein
the linkage mating area comprises two linkage openings penetrating the housing, the two linkage openings being configured to receive the first connecting rod and the second connecting rod, respectively.

12. The charging port or fueling port cover assembly of claim 1, wherein
the cover has a first side portion and a second side portion; and in a direction of moving the cover from the closed position to the open position, the first side portion is located upstream of the second side portion, and the connection of the linkage mechanism and the cover is proximate to the second side portion.

13. The charging port or fueling port cover assembly of claim 2, wherein
a substantially arc-shaped trajectory is formed by translational movement of the cover between the closed position and the open position.

14. The charging port or fueling port cover assembly of claim 1, wherein
the working area has a working opening for mounting a charging port or a fueling port.

15. The charging port or fueling port cover assembly of claim 4, wherein
the first connecting rod and the second connecting rod have substantially the same shape.

16. The charging port or fueling port cover assembly of claim 2, wherein
the linkage mechanism further comprises a transmission device connected to the first connecting rod and the second connecting rod, the transmission device being configured such that as one of the first connecting rod and the second connecting rod moves, the other thereof is driven to move via the transmission device.

17. The charging port or fueling port cover assembly of claim 16, wherein
the transmission device is arranged at parts of the first connecting rod and the second connecting rod away from the cover.

18. The charging port or fueling port cover assembly of claim 16, wherein
the transmission device is made of a rigid material.

19. The charging port or fueling port cover assembly of claim 16, wherein
the transmission device comprises a connecting member, two ends of the connecting member being pivotally connected to the first connecting rod and the second connecting rod, respectively.

20. The charging port or fueling port cover assembly of claim 16, wherein
the transmission device comprises a first gear, a second gear and at least one third gear, the first gear being fixedly connected to the first connecting rod, the second gear being fixedly connected to the second connecting rod, and the at least one third gear being meshable with the first gear and the second gear.
